(19) United States
(12) Patent Application Publication
(10) Pub. No.: US 2020/0195553 A1
(43) Pub. Date: Jun. 18, 2020

(54) SYSTEM AND METHOD FOR MEASURING PERFORMANCE OF VIRTUAL NETWORK FUNCTIONS

(71) Applicant: NETSIA, INC., Sunnyvale, CA (US)

(72) Inventors: BEYTULLAH YIGIT, ISTANBUL (TR); VOLKAN ALI ATLI, ISTANBUL (TR); ERHAN LOKMAN, ISTANBUL (TR)

(21) Appl. No.: 16/223,085

(22) Filed: Dec. 17, 2018

(51) Int. Cl. H04L 12/721; H04L 12/715; H04L 29/06; H04L 12/46; H04L 12/723; G06F 9/455; H04L 12/26

(52) U.S. Cl. CPC H04L 45/70; H04L 45/64; H04L 45/38; H04L 69/22; G06F 2009/45595; H04L 45/50; G06F 9/45558; H04L 43/0852; H04L 12/4645

(57) ABSTRACT

A probe virtual network function (VNF) is deployed in a software defined network (SDN), where the probe VNF computes delays and determines operation status of other VNFs as ‘available’ or ‘unavailable’ based on whether the computed delays are bounded or unbounded (or if a packet fails to arrive at a given VNF). The computed delay and the determined operation-status are then reported to a control function. The availability of such delay measurements using the probe VNF makes the routing algorithm within the controller more intelligent by incorporating the delay sensitivity of various service function chains.

### BACKGROUND OF THE INVENTION

### Field of Invention

The present invention relates to a system and a method for monitoring the service quality and availability of Virtual and Physical Network Functions in a Software Defined Network (SDN) using a special-purpose Virtual Network Function.

### Discussion of Related Art

Any discussion of the prior art throughout the specification should in no way be considered as an admission that such prior art is widely known or forms part of common general knowledge in the field.

A programmable network such as a Software Defined Network (SDN) is a new network infrastructure in which the control and data layers are separated. The data layer, which is controlled by a centralized controller infrastructure, is comprised of so-called ‘switches’ (also known as ‘forwarders’) that act as L2/L3 switches receiving instructions from the centralized controller using a standard protocol also known as OpenFlow (OpenFlow Switch Specification Version 1.5.1, 2014). SDN architecture has several benefits leveraging the centralized aspect of control such as global network visibility when it comes to route determination, network-wide routing consistency, easy support for QoS services, network slicing and network virtualization.

A key attribute of SDN is the decoupling of route determination and packet forwarding through separation of control and data planes. The controller performs route determination. The calculated routes are mapped into so called ‘flow rules/tables’, within the controller, which form the set of instructions prepared for each individual network switch precisely defining where and how to forward the packets of each packet flow passing through that switch. The ‘where’ part defines to which outgoing port of switch the packet must be sent, whereas the ‘how’ part defines what changes must be performed to each packet matching a criteria defined in the flow rules (changes in the header fields, for example). The controller sends the flow rules to each network switch and updates them as the network topology or services change. Route determination is attributed to the control plane, i.e., the controller, whereas packet forwarding is attributed to the data plane, i.e., the switches.

In the recent years, Network Function Virtualization (NFV) has become a cornerstone technology for SDN, which decouples network functions from the underlying hardware so that they can run as software images on commercial off-the-shelf hardware. It does so by using standard platforms (networking, computation, and storage) to virtualize the network functions. The objective is to reduce the dependence on dedicated, specialized and expensive physical devices by allocating and using the physical and virtual resources only when and where they are needed. With this approach, service providers can reduce overall costs by (a) shifting more components to a common physical infrastructure, (b) responding more dynamically to changing market demands by deploying new applications and services as needed, and (c) accelerating time to market for new services by streamlining service delivery. Contrary to virtual network functions, physical network functions (PNF) use special-purpose hardware optimized for the operation type of each PNF. Examples are load balancer and firewall. Although a PNF may be faster than a VNF for the same function, it has much higher per unit cost and more difficult to manage as each box is completely customized. For example, activation of a new VNF is software based and therefore extremely fast, while the activation of a new PNF is slow because of new hardware installation requirement.

Virtualized functions can use many different physical hardware resources as hosts (e.g., switches, routers, servers, etc.). First, a Virtual Machine (VM), which emulates the computer system's OS is installed on the host. There can be several VMs at the same time on the same host, each VM hosting a different virtual function. If the traffic is forwarded from one virtual function to another on the same host, a virtual switch (vSwitch) on that host performs the switching, meaning the traffic does not need to leave the host until all these services are delivered. A vSwitch acts just like a network switch with virtual Network Interface Cards (vNICs) switching packets across these vNICs from one VM to another on the same host. The host on which the vSwitch is deployed has at least one physical NIC to which all these vNICs map for the traffic entering and exiting the host. The physical NIC connects to another physical host/hardware platform. When NFV is deployed on an SDN, the virtual functions are typically hosted at SDN node locations where switches are employed. The virtual function is either hosted by the switch or on a server attached to the switch. A cluster of virtual functions may reside at the same node.

NFV already found itself a wide array of applications in (a) enterprise customer premises equipment (CPE), (b) 5G mobile network's new architecture, (c) data centers, and (d) residential home networking. Particularly, the new 5G mobile network architecture shifts completely from ‘network of entities' to’ network of functions' wherein well-known core network entities such as S-GW, P-GW, MME and HSS are now simple virtual functions distributed across the core network. Furthermore, these virtual functions are subdivided into the Control Plane (CP) and User Plane (UP) functions leveraging the SDN architecture's control and data plane separation. The User Plane Function (UPF), Access and Mobility Management Function (AMF), and Policy Control Function (PCF) are just a few examples of those newly defined virtual functions. Description and details of these functions can be found in 3GPP's 5G Architecture documents.

Deep Packet Inspection (DPI), Load Balancing, Network Address Translation (NAT), Firewall (FW), Parental Control, Intrusion Prevention System (IPS) and virtual Setup Box (vSTB) are just a few VNFs that are already deployed on hardware/server infrastructures. It may be more appropriate for a service provider to deliver virtualized network functions as part of a service offering. Service Function Chaining (SFC) is offered on an SDN that serves one or more virtual functions usually in a specific order along a user's data flow. For example, a mobile user's 5G data or control flow can be characterized as an SFC that traverses several 5G core network functions in a specific sequence before reaching the final destination. However, the choice of location and instance for a specific service function depends on the routing algorithm of an operator's 5G SDN.

It is found in studies that the packet transfer from the network switch to a Virtual Machine (VM) hosting the service function represents a significant performance overhead. This is especially troublesome with simple virtual network functions (VNFs) where the actual processing time can be comparable with this overhead. While the overhead is very small for Linux containers as VMs, for a granular service chaining architecture—with a lot of small VNFs—the network stack of the Linux kernel itself can cause bottlenecks. The overhead of virtualization has not been addressed in prior art.

When there are strict delay requirements for low-latency operations, a novel approach is needed to streamline the operations within a service chain. In addition to delay overhead, some virtual function instances may be overloaded with packet processing and therefore extremely slow to respond, or simply mal-functioning. Some virtual functions may also appear unavailable due to a VM or host failure. Utility software such as OpenStack, well known in prior art, can easily detect failure of a VM, but there are no capabilities available in OpenStack to determine if a VNF instance has functionally failed. The failure of a VNF may manifest itself by substantial increase in packet processing time (delay) and large difference between incoming and outgoing packet counts over a period of time. The Element Management System (EMS) software specific to each VNF type is therefore needed. However, building and deploying such EMS per VNF type is costly.

An intelligent packet routing scheme must be aware of status and performance of each VNF instance given that they may have many physical instances/realizations within an SDN. Thus, any path selection algorithm within an SDN to satisfy the service chain's quality of service requirements must take into account not only the availability of specific virtual functions on a chosen data path, but also the delay incurring due to selected specific instances of that virtual function. It is worthwhile to note that the aforementioned delay can be simply due to the characteristics (the specific operation) of the virtual function, and therefore static, or can be time-varying due to the current processing load of the function instance.

This invention describes a new type of Virtual Network Function (VNF) called ‘Probe VNF’ whose sole function is to test other VNFs for availability and processing delay, and report its results to the SDN controller or another monitoring platform, wherein either randomly-selected regular user data flows or synthetically-generated data flows are used for such testing. A Probe VNF is deployed at an SDN node just like any other VNF. There is a major distinction, however, the Probe VNF does not perform any services for the users' data flows, but instead for the network service provider by testing specified VNFs. Probe VNF has a plurality of external interfaces, at least a first interface to the SDN controller and a second interface is to the local SDN switch. The probe VNF operation and configuration are controlled remotely by a special control function that is either embedded within the SDN controller implemented as a sub-function, or built as an application of the controller implemented outside the controller. A single control function can control many probe VNFs.

According to an aspect of this invention, Probe VNF operates both in active mode and passive mode. In active mode, probe VNF generates a synthetic ‘test flow’ from time to time to send it to the neighbor VNFs for testing purposes only. A test flow can be generated (a) by the SDN controller, (b) by an external monitoring system that collects data from probe VNF, (c) randomly by the probe VNF, and/or (d) intelligently by the probe VNF using a learning algorithm that passively observes VNFs' behavior towards user data flows (e.g., determine which flows usually pass or fail in a DPI or firewall). In a passive mode, probe VNF's monitoring simply relies on observing actual user data flows that traverse neighbor VNFs. However, in the passive mode, there is no mirroring (or copying) of data flow packets. The probe VNF appears on a few selected actual user data flow's path simply to observe and record packet delay according to an aspect of this invention. A probe VNF can operate in either mode, or both modes, depending on its implementation. The probe VNF's mode and testing strategy are controlled by the SDN controller.

Another function of probe VNF is to test availability (i.e., up/down status) of a VNF. This can normally be achieved in passive mode or active mode. VNFs can be classified as type 1 —those VNFs that are inherently ‘packet-processing, and dropping’ such as DPI and Firewall, and type 2 —those VNFs that are inherently ‘packet-processing, but passing’ such as a UPF or SMF in 5G networks. For type 1, determining availability in passive mode is somewhat more difficult, because the virtual function drops packets inherent to its service. Therefore, the active mode testing is more suitable for type 1 availability determination, wherein the synthetic test flow is designed so that its passing through the virtual function without packet dropping is guaranteed under normal operations. If packet drops are substantial in active mode, then it is a strong indication of a failure. For type 2, availability can be determined more easily.

Probe VNF can be operated in (a) testing availability mode, (b) testing delay mode, or (c) both.

The control function of probe VNF activates each test cycle of the probe VNF. Because the probe VNF must either be on actual user data flow path, in passive mode, or generate test flows, in active mode, and send them to the neighbor VNFs, the controller must not only trigger this activity cycle and send relevant information to probe VNF, but it must also send corresponding flow rules to switches using OpenFlow that entail a special service function chaining (SFC) that includes the probe VNF in the chain's path. Furthermore, probe VNF must report the results of a testing cycle to the control function (within the controller or an application of the controller) and optionally an external VNF monitoring application. Doing so, the controller will be aware of up/down status and delay of each VNF in its network.

All functions of probe VNF are applicable to measurement of delay and availability to PNFs as well as VNFs. It should be understood that although PNFs are not mentioned in what follows, it should be assumed that the system and method of invention are applicable PNFs as well as VNFs. Furthermore, probe VNF can be implemented as a PNF without loss of functionality. Therefore, probe PNF is within the scope of this invention.

ETSI's NFV standards describe a key software component called ‘orchestrator’, which is responsible for activating new service functions, lifecycle management, global resource management, and validation and authorization of NFV resource requests. However, a distributed system such as a probe VNF deployed as a VNF at node locations is not specified in the standards.

SDN switches can be programmed to measure various delay components during the processing of packet flows and to report these delays to the controller in real-time. It can measure the packet delay within a particular buffer, across a switch (i.e., between any two ports of a switch, across multiple switches, or of a virtual function associated with the switch (either the function is on-board, or on a server directly attached to one of the switch port). In-band Network Telemetry is a framework designed particularly for the collection and reporting of the network state, directly from the data plane. Switches simply augment the user's data flow's packet header that matches a criterion specified by the controller (i.e., an SFC flow), by the action of inserting specific telemetry data into the packet header. Packets contain header fields that are interpreted as “telemetry instructions” by the switches. The INT starts at an ‘INT Source’, which is the entity that creates and inserts the first INT Headers into the packets it sends. INT terminates at an ‘INT Sink’, which is the entity that extracts the INT Headers, and collects the path state contained in the INT Headers. The INT header contains two key information (a) INT Instruction—which is the embedded instruction as to which metadata to collect and (b) INT Metadata—which the telemetry data the INT source or any transit switch up to the INT sink inserts into the INT header. The switch that is the INT source of the packet flow receives a match-action criteria to insert an INT header into each packet's header in the form of an INT instruction plus INT metadata, all transit switches along the flow path simply inspect the INT instruction in the header and insert their INT metadata, and the switch (or a host) that is the INT sink removes the INT header and sends all the INT metadata to a monitoring application. The drawback of this method is the big packet overhead for monitoring, and thus must be used sparingly.

The availability of such delay measurements using Probe VNF makes the routing algorithm within the controller much more intelligent particularly because of incorporating the delay sensitivity of certain service function chains.

Embodiments of the present invention are an improvement over prior art systems and methods.

### SUMMARY OF THE INVENTION

In one embodiment, the present invention provides a method as implemented in a software defined network (SDN), the SDN comprising: at least one controller, a plurality of switches controlled by the at least one controller, a first virtual network function (VNF₁) providing a telecommunications service to a packet data flow traversing said network, a second virtual network function (VNF₂) providing a service of measuring a delay and an availability of VNF₁, and an interface between VNF₂ and a control function, the method comprising: (a) receiving a request from the control function for measuring a delay of VNF₁ using a specific packet data flow; (b) storing a first arrival time, t₁, and an identifier associated with at least one packet in the specific packet flow, wherein the at least one packet in the specific packet flow arrives for a first time at VNF₂ prior to traversing VNF₁; (c) storing a second arrival time, t₂, of the at least one packet when receiving the specific packet data flow after traversing VNF₁; (d) computing delay of VNF₁ as t₁-t₂; (d) determining an operation status of VNF₁ as ‘available’ when the computed delay of VNF₁ is bounded, and determining the operational status of VNF₁ as ‘unavailable’ when the computed delay is either larger than a predetermined threshold or when the at least one packet fails to arrive after traversing VNF₁; and (e) reporting the computed delay and the determined operation-status of VNF₁ to the control function.

In another embodiment, the present invention provides a method as implemented in a software defined network (SDN) comprising: at least one controller, a plurality of switches, each switch in the plurality of switches programmable to use In-Band Telemetry (INT), the plurality of switches controlled by the at least one controller, a first virtual network function (VNF₁) providing a service to a user's packet data flow traversing said network attached to a first switch, a second virtual network function (VNF₂) providing a service of measuring a delay and an availability of VNF₁, and an interface between VNF₂ and a control function, the method comprising: (a) receiving a request from the control function for measuring a delay of VNF₁ using a specific packet data flow; (b) the first switch inserting an In-Band Telemetry (INT) header at a first time of arrival, t₁, of a packet, prior to sending the packet to VNF₁, and recording the first time of arrival, t₁; (c) the first switch updating the INT header at a second time of arrival, t₂, of the packet after receiving packet from VNF₁, and recording the second time of arrival, t₂; (e) the first switch sending the packet to VNF₂; (f) the VNF₂ receiving the packet with the updated INT header and stripping off the INT header; (g) the VNF₂ storing t₁ and t₂ and an identifier associated with the specific packet flow, (h) computing delay of VNF₁ as t₁-t₂; (i) determining an operation status of VNF₁ as ‘available’ when the computed delay of VNF₁ is bounded, and determining the operational status of VNF₁ as ‘unavailable’ when the packet fails to arrive at VNF₂; and (j) reporting the computed delay and the determined operation-status of VNF₁ to the control function.

In yet another embodiment, the present invention provides a system implemented in a software defined network (SDN) comprising: (a) a database storing information regarding: (1) one or more virtual network functions (VNFs), (2) one or more packet flows, (3) delays associated with VNFs, and (4) availability of VNFs; (b) an interface to a control function to receive requests and to report results; (c) a flow processor receiving at least one packet flow in the one or more packet flows from a switch in a passive mode, the flow processor processes messages from a controller regarding starting a test cycle; (d) a time collector receiving the at least one packet flow processed by the flow processor for extraction and recordation of timing information for delay estimation, the time collector extracting a packet identifier and associated arrival time of the incoming packets and storing extracted information in the database, wherein when a same packet within the at least one packet flow arrives at the time collector after being processed by a VNF within the one or more VNFs, recording the arrival time, estimated delay, and availability information in the database; (e) a reporter reporting the estimated delay and availability information to the controller and a monitoring application; and (f) a test flow generator generating one or more synthetic test packet flows for active mode testing, wherein the one or more synthetic test packet flows are any of the following: (1) first flow that is stored in the database for active mode testing, (2) a second flow that is generated according to a specific VNF's testing purposes, (3) a third flow that is generated by an intelligent flow selector meeting a predefined criterion, and (4) a fourth flow sent by the controller for testing purposes only.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 illustrates an SDN with NFV (prior art).

FIG. 2 illustrates an SDN node with two virtual functions and probe VNF according to the present invention.

FIG. 3 depicts a simple flow chart illustrating an exemplary packet routing in a simple SFC with two VNFs.

FIGS. 4A and 4B depict simple flow charts illustrating the multicast method for passive monitoring with system of invention.

FIG. 5 depicts a simple flow chart illustrating the unicast method for passive monitoring with system of invention.

FIG. 6 depicts a simple flow chart illustrating active monitoring with system of invention.

FIG. 7 depicts a simple flow chart illustrating INT-based passive monitoring with system of invention.

FIG. 8 shows a high-level block diagram of probe VNF.

FIG. 9 illustrates an exemplary messaging flow according to an aspect of this invention.

FIG. 10A shows a high-level block diagram of the first embodiment of the control function according to invention.

FIG. 10B shows a high-level block diagram of the second embodiment of the control function according to invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

An electronic device (e.g., a router, switch, orchestrator, hardware platform, controller etc.) stores and transmits (internally and/or with other electronic devices over a network) code (composed of software instructions) and data using machine-readable media, such as non-transitory machine-readable media (e.g., machine-readable storage media such as magnetic disks; optical disks; read only memory; flash memory devices; phase change memory) and transitory machine-readable transmission media (e.g., electrical, optical, acoustical or other form of propagated signals-such as carrier waves, infrared signals). In addition, such electronic devices include hardware, such as a set of one or more processors coupled to one or more other components—e.g., one or more non-transitory machine-readable storage media (to store code and/or data) and network connections (to transmit code and/or data using propagating signals), as well as user input/output devices (e.g., a keyboard, a touchscreen, and/or a display) in some cases. The coupling of the set of processors and other components is typically through one or more interconnects within the electronic devices (e.g., busses and possibly bridges). Thus, a non-transitory machine-readable medium of a given electronic device typically stores instructions for execution on one or more processors of that electronic device. One or more parts of an embodiment of the invention may be implemented using different combinations of software, firmware, and/or hardware.

As used herein, a network device such as a switch, router, controller, orchestrator or host is a piece of networking component, including hardware and software that communicatively interconnects with other equipment of the network (e.g., other network devices, and end systems). Switches provide network connectivity to other networking equipment such as switches, gateways, and routers that exhibit multiple layer networking functions (e.g., routing, layer-3 switching, bridging, VLAN (virtual LAN) switching, layer-2 switching, Quality of Service, and/or subscriber management), and/or provide support for traffic coming from multiple application services (e.g., data, voice, and video).

Any physical device in the network is generally identified by its type, ID/name, Medium Access Control (MAC) address, and Internet Protocol (IP) address. A virtual function runs on a physical platform that can be the switch or a server attached to the switch. There may be several instances of the same virtual function or different types of virtual functions on the same physical platform. The controller of the SDN can run on a single server or may be distributed on several servers. At any point in time, one controller may be the master while others are slaves. Alternatively, the plurality of controllers may be in a peer mode. The controller is attached to each switch in the network.

Note that while the illustrated examples in the specification discuss mainly NFV (as ETSI defines) relying on SDN (as Internet Engineering Task Force [IETF] and Open Networking Forum [ONF] define), embodiments of the invention may also be applicable in other kinds of distributed virtualized network function architectures and programmable network architectures, not necessarily tied only into NFV and SDN.

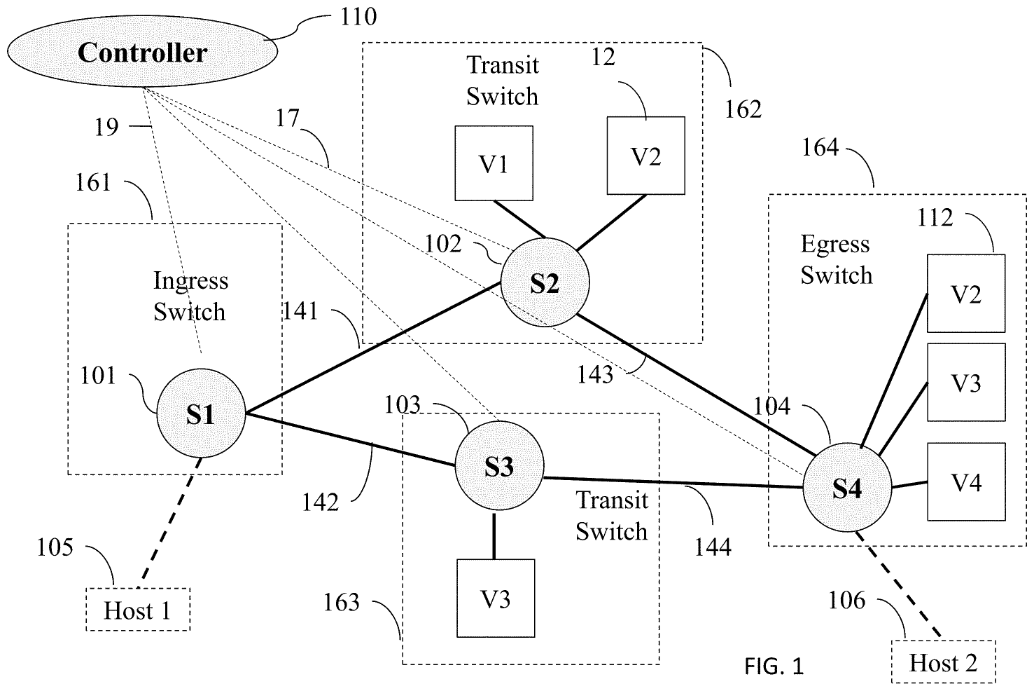

FIG. 1 illustrates a simple exemplary SDN network with four switches, S1 (101), S2 (102), S3 (103) and S4 (104). Switches S1 and S2 are interconnected with transmission facility 141, S1 and S3 are connected with transmission facility 142, S2 and S4 are connected with transmission facility 143, and S3 and S4 are connected with transmission facility 144, forming the network topology. Controller 110 has an out-of-band control network towards switches S1, S2, S3 and S4. Links 17 and 19 that attach controller 110 to switches S2 and S1, respectively, are part of the out-of-band control network, which is used by the controller to control the switches by sending and receiving control (e.g., OpenFlow) messages. Although the control network is illustrated as an out-of-band network, it can also be an in-band network wherein control connections share the same facilities with data connections.

The virtual network functions are distributed to these four switching nodes. There are four types of virtual functions: V1, V2, V3 and V4. There are different instances of these virtual functions deployed in switching node locations 162, 163 and 164.

In an exemplary embodiment, each aforementioned virtual function is hosted on a separate physical host attached to a physical switch port as illustrated in FIG. 1. Many other feasible embodiments provide the same VNF distribution of FIG. 1. For example, in another exemplary embodiment, V2, V3 and V4 at switching node 164 are all deployed on the same physical host, each function encapsulated in a Virtual Machine (VM), with a first vSwitch on that host switching across these functions, when needed. In yet another exemplary embodiment, V2 at egress switching node 164 is deployed on a first host attached to S4 (104), and V3 and V4 deployed on a second host, also attached to S4 (104) with a second vSwitch deployed on that second host switching between V3 and V4, the vSwitch directly attaching to S4 (104) via the physical host's NIC. Various such implementations can be enumerated for the VNFs at switch locations 162.

In this simple example scenario, an SFC flow is defined between host 1 (105) and host 2 (106). This flow contains services {V1, V2, V3 and V4}, in that specific order. Ingress switch S1 (104) will perform the traffic classification (i.e., where a tag is inserted to identify the particular SFC), switching nodes 162 is a possible alternative transit node location, and switching node 164 is the egress switch node where the tag is removed, and the flow is delivered to host 106. Note that traffic must first pass through node 162 to receive service V1; there are no other instances of V1 in the network. V2 can be delivered either at node 162 or node 164; there are two feasible instances of V2. V3 and V4 are both hosted at node 164 and must be delivered at that node.

Although there are two feasible data routes for the traffic: r1={S1->S2->S4} and r2={S1->S3->S4} between host 1 and host 2, because of the SFC requirement, only r1 is a feasible path for the service-chain. The controller must now decide to use whether the V2 instance at node 162 or node 164 depending on the delay and availability of this function at these locations.

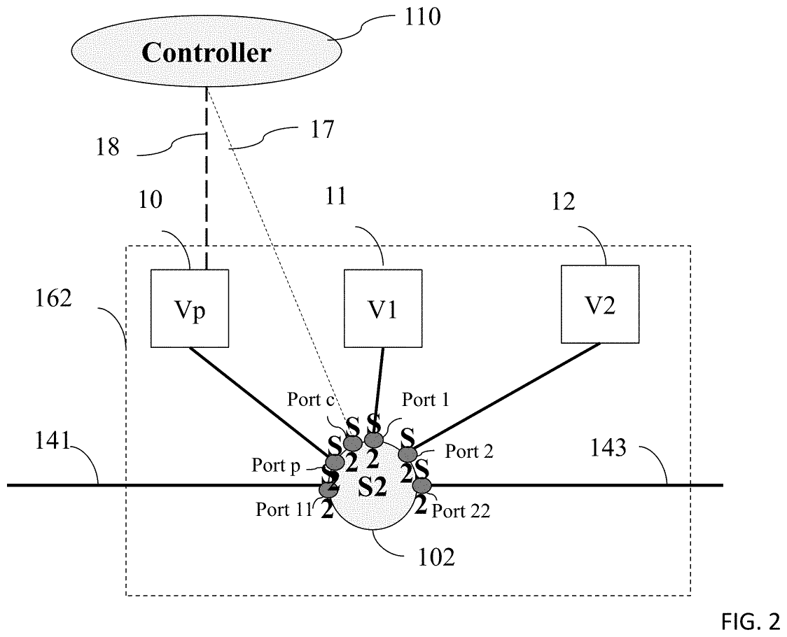

FIG. 2 shows a simple embodiment of the invention at node 162, wherein a probe VNF, Vp (10), is deployed along with V1 (11) and V2 (12). Vp (10) can be deployed on its own host, or on the same host with V1 and/or V2 using a different Virtual Machine (VM). If Vp (10) is deployed on the same host with virtual functions, then the vSwitch is used to switch across them. If it is deployed on a different host, then S2 is used to switch between Vp (10) and other virtual functions. Controller 110 has an interface to S2 and, according to an aspect of this invention, has an interface (e.g., using a RESTful API) towards Vp (10) to program the probe VNF, or to receive delay and availability data from probe VNF.

A simple data flow that has a SFC={V1, V2}, in that order, enters node 162 at switch S2, Port 11. The flow then goes towards V1 (11) at Port 1 and returns back at Port 1 after the service is obtained, and then it goes towards V2 (12) at Port 2 and returns at Port 2 after the service is obtained, and finally it exists node 162 at Port 22.

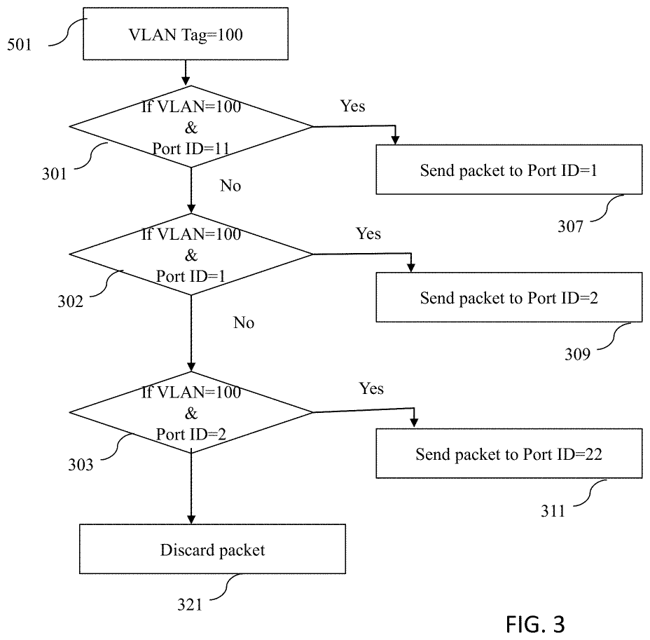

The sequence of operations and the corresponding flow rules in S2 are illustrated in a simple flow chart in FIG. 3. First, a VLAN tag 100 (or another type of tag such as Network Service Header (NSH) or MPLS tag identifying the flow) is inserted to the packets of the flow at step 501. This tag is inserted at S1 (entry point of the flow). Switch S2 looks up its flow table at step 301, checks to determine if incoming flow's VLAN tag=100 & Port Id=11, and then as the next hop, S2 sends the flow to Port 1 at step 307. Else, at step 302, if incoming flow's VLAN tag=100 but Port Id=1, then as the next hop, S2 sends the flow to Port 2 at step 309. Else, at step 303, if incoming flow's VLAN tag=100 but Port Id=2, then as the next hop, S2 sends the flow to Port 22 at step 311. Else, S2 discards the packet at step 321. This sequence clearly shows how data traffic enters the switch multiple times from different ports while the service chain is being realized. The packet forwarding is performed by S2 simply using flow rules that describe the forwarding sequence.

In a first embodiment of this invention, the probe VNF measures the delay and availability of virtual functions deployed at the same node using a ‘multicast method’ in ‘passive mode’. In this method, when a switch sends a user's packet flow to a first VNF located at the same node, it is simultaneously sent, in multicast mode, to Probe VNF (meaning the switch sends one copy of the packet flow to probe VNF). While said first VNF processes each packet to deliver the service (e.g., service type 1), Probe VNF only logs a packet identifier (e.g., a VLAN/MPLS/NSH tag and a packet sequence number) and a time stamp for each packet that enters probe VNF for the first time, and then discards the packet. When the switch sends the same flow, in the sequence of the SFC, to a second VNF at the same node, it simultaneously sends it to Probe VNF, using multicasting. While said second VNF processes each packet to deliver its service (e.g., service type 2), Probe VNF only logs the aforementioned packet Id and a time stamp for each packet that enters probe VNF for the second time, and then discards the packet. The difference between said second time and first time for the same packet identifier gives the delay of the first VNF, assuming the switching delay in service types 1 and 2 is negligible. If this delay is not negligible, then it has to be subtracted from said difference as well. The switch may easily monitor its own switching delay from time to time and report to the controller for better accuracy. If packets that are sent to first VNF (and to probe VNF for the first time) never come back to probe VNF for the second time, then the first VNF is declared unavailable, meaning packets are not being processed. According to an aspect of the invention, S2 can be instructed by the controller to send only a few packets of the user's packet flow to probe VNF as opposed to the entire packet flow.

In virtual functions that drop packets as part of their service, such as DPI and firewall, the probe VNF can only use ‘active mode’ wherein a flow of packets is synthetically generated that are guaranteed to pass through these service components as opposed to using actual (user's) live flows so that packets return to probe VNF.

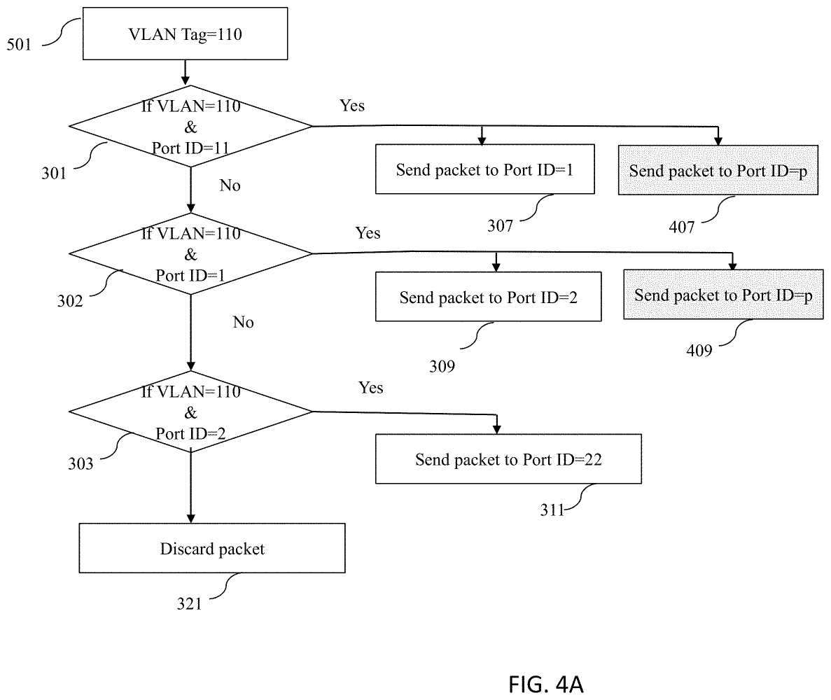

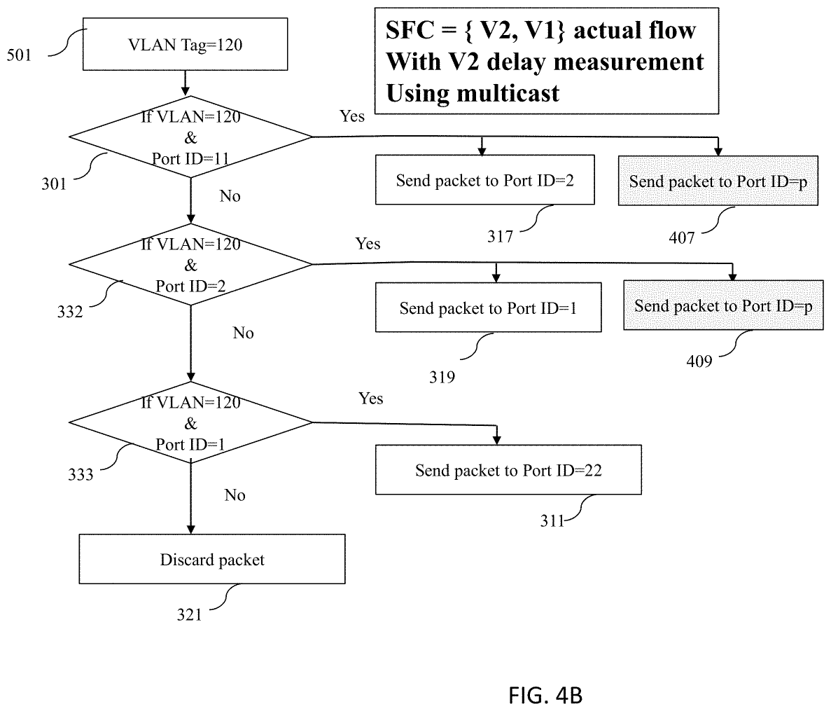

FIG. 4A depicts the simple flow rules in switch S2 implementing the first embodiment (multicast mode) to measure the delay of V1 using a SFC={V1, V2}. First, a VLAN tag 110 (or another type of tag such as NSH or MPLS tag identifying the flow) is inserted to the packets of the flow at step 501. This tag is likely inserted at S1 (entry point of the flow). Switch S2 looks up its flow table at step 301 and checks to determine if incoming flow's VLAN tag=110 & Port Id=11, then as the next hop, S2 sends the flow to Port 1 at step 307 and to Port Pd at step 407 (all or some packets). Else, at step 302, if incoming flow's VLAN tag=110 but Port Id=1, then as the next hop, S2 sends the flow to Port 2 at step 309 and to Port Pd at step 409 (all packets that were sent to Pd before). Else, at step 303, if incoming flow's VLAN tag=110 but Port Id=2, then as the next hop, S2 sends the flow to Port 22 at step 311. Else, S2 discards the packet at step 321.

Similarly, FIG. 4B depicts the simple flow rules in switch S2 implementing the first embodiment to measure the delay of V2 in SFC={V2, V1}. First, a VLAN tag 120 (or another type of tag such as NSH or MPLS tag identifying the flow) is inserted to the packets of the flow at step 501. This tag is inserted at S1 (entry point of the flow). Switch S2 looks up its flow table at step 301 and checks to determine if incoming flow's VLAN tag=120 & Port Id=11, then as the next hop, S2 sends the flow to Port 2 at step 317 and to Port Pd at step 407. Else, at step 332, if incoming flow's VLAN tag=120 but Port Id=2, then as the next hop, S2 sends the flow to Port 1 at step 319 and to Port Pd at step 409. Else, at step 303, if incoming flow's VLAN tag=120 but Port Id=1, then as the next hop, S2 sends the flow to Port 22 at step 311. Else, S2 discards the packet at step 321.

In a second embodiment of this invention, the probe VNF measures the delay and/or availability of virtual functions deployed at the same node using a ‘unicast method’ in ‘passive mode’, i.e. using actual user flows. Let us consider the same SFC={V1, V2} and a Probe VNF at node 162 attached to S2, wherein Probe VNF measures the delay of V1 and V2. Using this method, the switch first sends the user's packet flow to Probe VNF (first entry to Probe VNF). Probe VNF creates a time stamp (stored in a database) for each packet of the flow. Then, the switch sends the packet flow to first VNF (V1) located at the same node, and after receiving service type 1 at V1, S2 sends the packet flow back to Probe VNF (second entry to Probe VNF). Then, S2 sends the packet flow to second VNF (V2) located at the same node, and after receiving service type 2 at that VNF, and S2 sends the packet flow back to Probe VNF (third entry to Probe VNF). Probe VNF logs a packet identifier (e.g., a VLAN/MPLS/NSH tag and a packet identifier such as a sequence number) for each packet of the flow and the three time stamps, i.e., for the first, second and third times. The difference between the second and first times is the delay of V1. The difference between the third and second times is the delay of V2, assuming the switching delay in between service type 1 and 2 is negligible. If this delay is not negligible, then it has to be subtracted from said differences as well. If packets that are sent to V1 or V2 don't come back to probe VNF after the first or second entry, respectively, then V1 or V2 is declared unavailable.

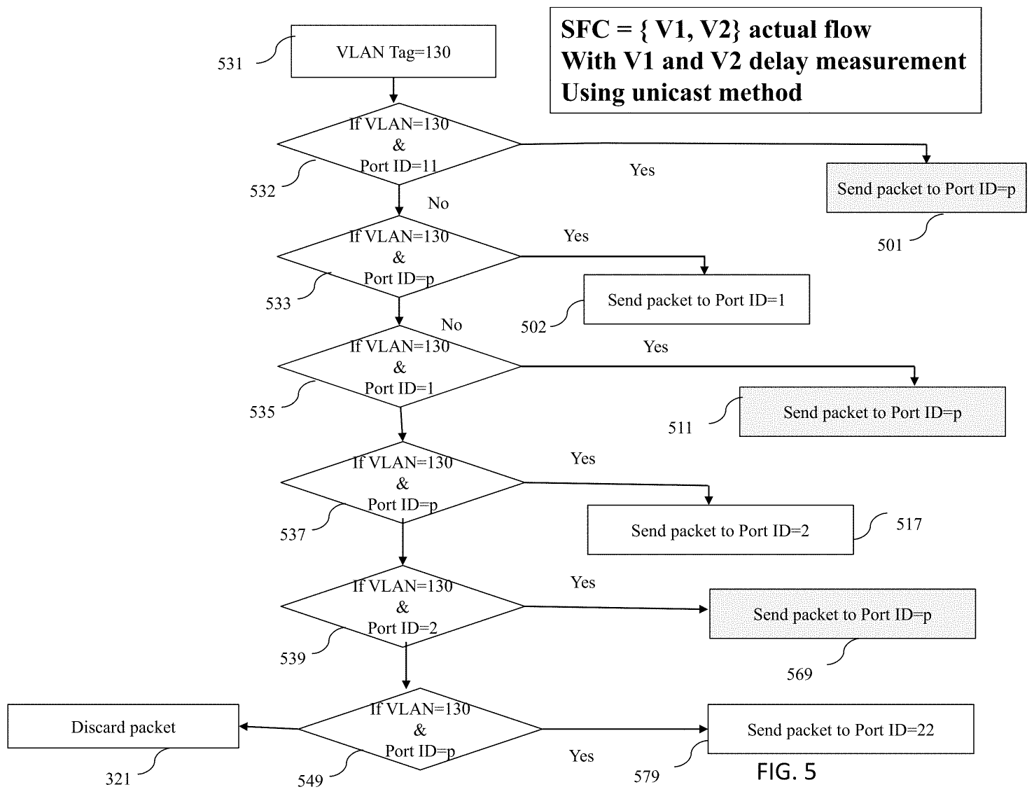

FIG. 5 depicts the simple flow rules in switch S2 implementing the second embodiment to measure the delay of V1 and V2 in SFC={V1, V2}. First, a VLAN tag 130 (or a type of tag other than VLAN such as NSH or MPLS identifying the flow) is inserted to the packets of the flow at step 531. This tag is inserted at S1 (entry point of the flow). Switch S2 looks up its flow table at step 532 and checks to determine if incoming flow's VLAN tag=130 & Port Id=11, then as the next hop, S2 sends the flow to Port Pd (for the first time) at step 501. Else, at step 533, if incoming flow's VLAN tag=130 but Port Id=Pd, then as the next hop, S2 sends the flow to Port 1 at step 502. Else, at step 535, if incoming flow's VLAN tag=130 but Port Id=P1, then as the next hop, S2 sends the flow to Port Id=Pd (for the second time) at step 511. Else, at step 537, if incoming flow's VLAN tag=130 but Port Id=Pd, then as the next hop, S2 sends the flow to Port 2 at step 517. Else, at step 539, if incoming flow's VLAN tag=130 but Port Id=P2, then as the next hop, S2 sends the flow to Port Pd for the third time at step 569. Else, at step 549, if incoming flow's VLAN tag=130 but Port Id=Pd, then as the next hop, S2 sends the flow to Port 22 at step 579. Else, S2 discards the packet at step 321. Because the same packet comes back to the switch from Pd multiple times in this scenario, S2 must keep the history of packet arrivals in executing the rules to properly forward the packet. The second embodiment can be implemented as a separate measurement sequence for each individual VNF's delay measurement by following the rule of {Pd->Pi->Pd} sequence for Vi attached to the switch S2 at port Pi. The delay of Vi is then simply the time difference between second and first time Pd entry. For the above example, a combined sequence of {Pd->P1->Pd->P2->Pd} is employed to simplify the operations.

In a third embodiment of this invention, the probe VNF measures the delay and/or availability of virtual functions deployed at the same node using ‘active mode’, i.e. using synthetically generated test flows. If V1's delay is measured, Probe VNF at node 162 attached to S2, generates a test flow and sends to the switch for measurement purpose only.

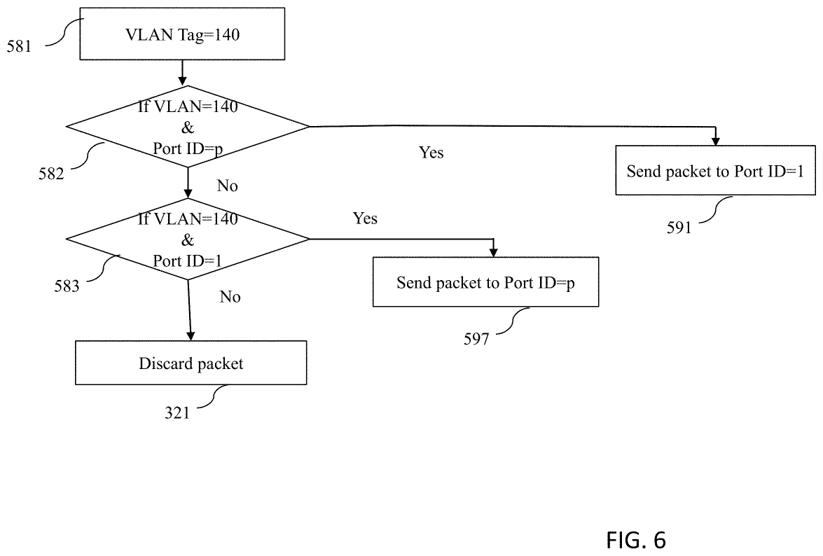

This flow originates at Probe VNF and enters switch S2 at Pd. S2 has a flow rule programmed by the controller that instructs the switch to send this flow that has originated from Probe VNF towards V1 at Port P1 first, and then when the flow comes back from V1 back to Probe VNF at Port Pd. FIG. 6 illustrates this simple scenario wherein Probe VNF generates the flow sequence with VLAN tag=140 at step 581. S2 looks up the flow rules and determines to send this flow to P1 towards V1 at step 591. When the flow comes back from V1 at port P1, at step 583, the flow is sent back to Probe VNF at step 597. Else, the flow is discarded at step 321. This embodiment is much simpler than the first and second embodiments and may indeed find a useful application in cases where the VNF, whose delay is to be measured, inherently drops packets as a nature of its service or using actual flows is cumbersome. However, this method may not be giving as realistic times as using live flows.

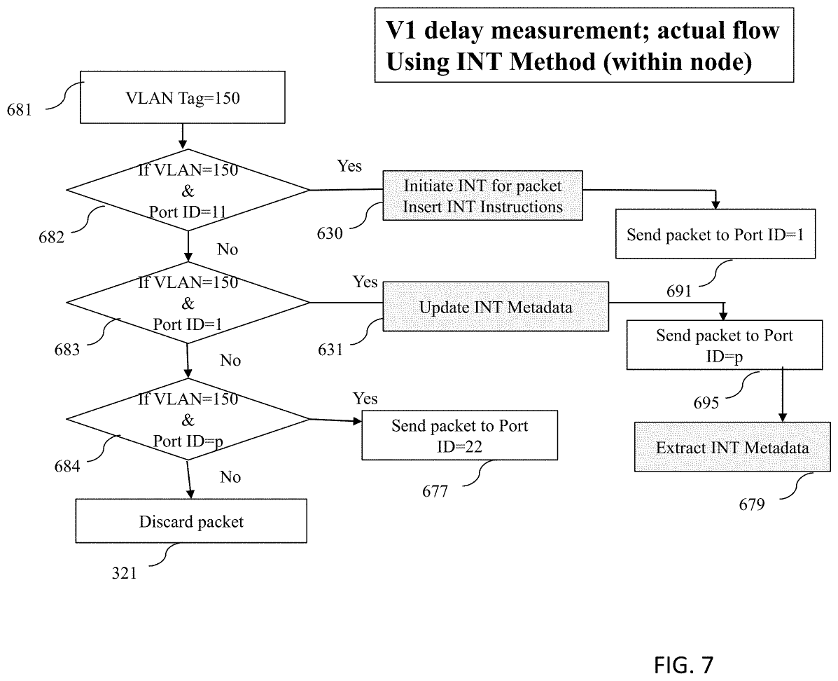

In a fourth embodiment of this invention, the switch S2 can be programmed to use the In-band Telemetry, INT, method for delay measurements. In this embodiment, the switch S2 acts as an INT source, entering INT instructions before a packet flow enters V1, marking times of V1 entry and exit into each packet as metadata, and finally sending the packets with INT header to Probe VNF. In turn, Probe VNF acts as the INT sink, extracting the INT header, reading the metadata engraved into each packet's header, and sending the original packet back to the switch as illustrated in FIG. 7. A data flow sequence with VLAN tag=150 arrives at S2 at step 682 from port 11. S2 looks up the flow rules and determines that it has to insert an INT header for these packets. It updates the metadata of the inserted INT header with the current time in step 630. Subsequently, S2 sends the packet flow with the INT header to V1 at port P1 at step 691. When the flow arrives from V1 at port P1, V1 provides the service type 1 and return the packet flow back to S2. At step 683, S2 checks to determine if VLAN tag=150 and the packet is coming from P1. If so, it inserts the arrival time of the packet into INT header at step 631 and sends the packet to Port Pd at step 695. Probe VNF extracts INT metadata, strips off the INT header, and sends the original packet flow (without the INT header) back to S2. Subsequently, S2 checks to determine if VLAN tag=150 and the packet is coming from Pd at step 684. If so, it sends the packet to the outgoing port, 22, at step 677, and else discards it at step 321. The INT method can be used in both active and passive modes.

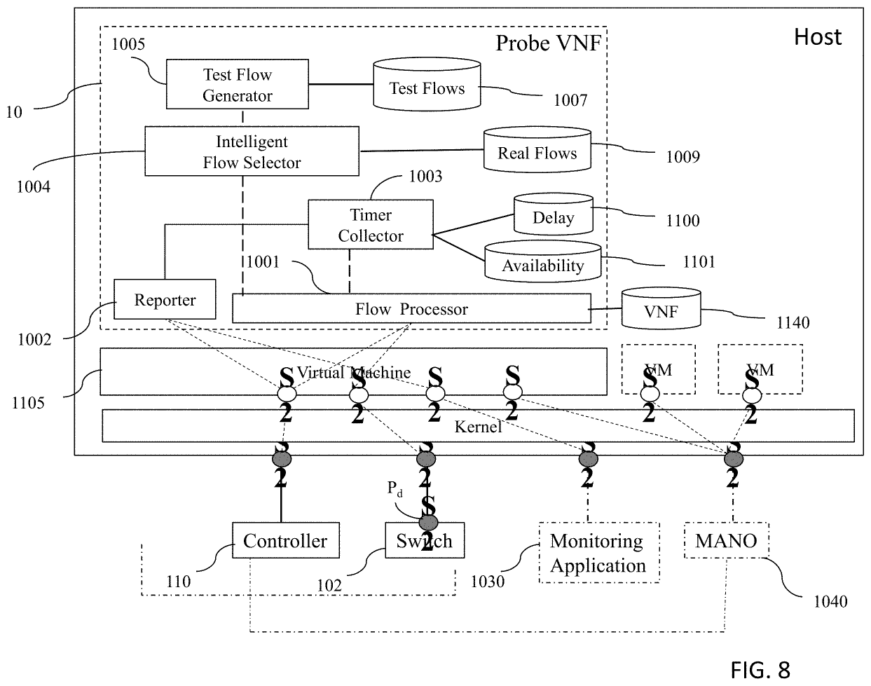

A simple block diagram showing major functions of probe VNF is shown in FIG. 8. It is illustrated on a host that has a plurality of Virtual Machines (VMs). While one VM is used by Probe VNF 10, other VMs can be used for other VNFs. One of the key interfaces of Probe VNF 10 is to Controller 110 that is used to control Probe VNF 10. Controller 110 can configure a Probe VNF, initiate a VNF testing and receive reports through this interface. Probe VNF has an interface to Switch 102 (via port Pd) to send and receive packet flows. It is Controller 110's function to ensure that Switch 102 and Probe VNF 110 act in complete synchronicity by sending corresponding flow rules to Switch 102 while sending testing messages to Probe VNF to test packet flows. This applies to both passive mode and active mode testing. Optional interfaces to MANO 1040 and Monitoring Application 1030 are also illustrated.

The interface to Controller 110 is a simple interface such as the RESTful API well known in prior art that uses HTTP protocol messages. The controller interface is used for many simple control functions of Probe VNF. There are three key exemplary messages between Controller 110 and Probe VNF 10. There may be more messages, or these messages may be structured differently or merged together in other possible embodiments:

(a) CONFIG_VNF—The message is from Controller 110 to configure Probe VNF 10. It contains information about Probe VNF's configuration (connectivity info, default testing method, default timers, max. no of packets to be used in testing, etc.), as well as its neighbor VNF configuration for which Probe VNF 10 has responsibility of testing. Neighbor's VNF configuration includes VNF Identifier (e.g., IP and MAC addresses), VNF type (e.g., packet blocking, or packet processing), VNF function name (e.g., UPF, SMF). The VNF configuration is stored in the VNF database within Probe VNF 10. From time to time, Controller 110 may update configuration information.

(b) TEST_VNF—The message is sent from Controller 110 to Probe VNF 10 to initiate a testing cycle for one or more VNFs. It includes an identifier of the flow to be tested (e.g., VLAN tag), the Service Function Chain (SFC) including at least one VNF to be tested (usually a plurality of VNFs in a specified order), and the testing methodology, which is information such as use of unicast or multicast, passive or active mode or INT mode. The CONFIG message will define a ‘default testing’ strategy, such as unicast method in passive mode with no-INT.

(c) REPORT_VNF—The message is sent from Probe VNF 10 to Controller 110 to report the results of the test initiated by the TEST_VNF. It includes the information to associate to TEST_VNF message and measurement results such as minimum, maximum and median delay, availability status (up/down), measurement time period, measurement certainty estimate, etc.

Probe VNF 10 has an interface to Switch 102 to send and receive packet flows in passive and active modes for measurement purposes. If Controller 110 initiates a testing cycle in Probe VNF 10, and it must send the corresponding flow rules/tables in parallel to switches.

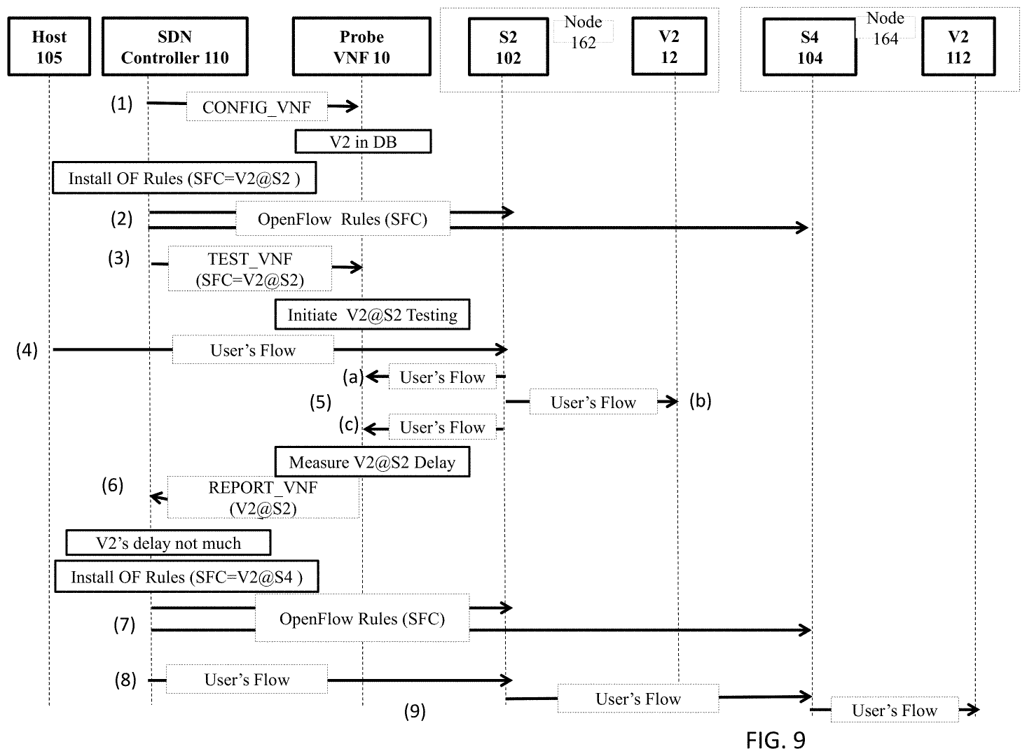

FIG. 9 illustrates a diagram of an exemplary sequence of messages that engages various components of the method of invention. In this scenario, virtual function type V2 has two instances, V2 (12) at node 162, which is attached to switch S2 (102) (denoted as V2@S2 in the messages in the diagram), and V2 (112) at node 164, which is attached to switch S4 (104) (denoted as V2@S4 in the messages in the diagram). These components are clearly illustrated in network diagram of FIG. 1. The control function resides within SDN Controller 110 that has an interface to Probe VNF 10, and OpenFlow (OF) connections to switches S2 (102) and S4 (112).

Host 105 starts a packet flow that requires the service type V2 (i.e., SFC=V2) along its route. In this scenario, Controller 110 initially decides to use the instance of V2 at S2, V2@S2, for this flow. Meanwhile, it decides to request Probe VNF 10 to test V2@S2 for delay and availability, and report back. First, at step (1) SDN Controller 110 configures Probe VNF 10 with V2@S2 by sending CONFIG_VNF message. In turn, Probe VNF 10 stores configuration data of V2@S2 in the VNF database. SDN Controller 110 determines the flow rules for S2 such that Host 105's data flow first enters S2 (say, with a VLAN tag of 120, which is inserted to the packets at S1 (shown in FIG. 1), which acts as the traffic classifier), then sent by S2 to Port ID=Pd, i.e., towards Probe VNF 10 for the first time, then towards V2@S2 to receive the service of V2, then back to S2, then sent by S2 back to Port ID=Pd towards Probe VNF for the second time, and then out towards S4. SDN Controller 110 determines the flow rules for S4 as well to route the packet towards its final destination. At step (2) SDN Controller 110 sends the flow rules to S2 and S4 using OpenFlow. Next, SDN Controller 110 sends a TEST_VNF message at step (3) to Probe VNF 10 to test V2@S2. This message specifies an identifier of the flow, VLAN tag=120, identifier of the virtual function to be tested, SFC=V2, and the testing method, i.e., unicast method in passive mode. Probe VNF 10 will conduct testing accordingly. At step (4) user data flow starts. According to step (5), when the flow arrives at S2, it sends the flow in the proper sequence between Probe VNF and V2@S2 to enable the testing of delay using the unicast method according to flow rules it received at step (2). At step (6), Probe VNF 10 reports the measured delay to control function within SDN Controller 110, which checks to determine if the delay meets the delay requirements. Because the delay of V2@S2 is too high, it determines to switch the traffic over to V2@S4 from V2@S2, and changes the flow rules accordingly in S2 and S4, in steps (7) and (8). Finally, user flow in step (9) transits through S2 towards S4 and receive V2 service at S4 as shown in step (10).

Probe VNF 10 has several key functions:

1. Flow Processor 1001 receives packet flows from switch 102 in passive mode and routes the packet flow to other internal sub-functions for different types of processing. Flow processor also processes the messages from Controller 110 concerning starting a test cycle. Along with the VNF configuration, all rules associated with a specific testing cycle of a VNF are stored in VNF database 1140. Such information is (a) flow identifier, (b) SFC, (c) active, or passive mode (A or P) operations, (d) INT mode (yes or no), (e) unicast or multicast method and duration (U or M). Flow Processor 1001 sends each processed flow to Timer Collector 1003 for extraction and recordation of timing information for delay estimation. Flow Processor 1001 also sends the flow to Intelligent Flow Selector 1004 for evaluation and processing of the flow as a candidate to become the synthetic test flow.

2. Time Collector 1003 extracts packet identifier and associated arrival time of the incoming packets and stores the information in delay database 1100. When the same packet arrives at the Time Collector after being processed by a VNF, the arrival time is recorded, and the delay estimated. Time Collector 1003 stores delay information in Delay DB 1100 and the availability information in Availability DB 1101.

3. Reporter 1002 is a function associated with Timer Collector to report delay and availability to Controller 110 and Monitoring Application 1030. Reporter 1002 relies on the information in Delay and Availability DBs as well as VNF DB 1140, which stores the information associated with the VNFs being tested.

4. Test Flow Generator 1005 is responsible for generating synthetic test packet flows for active mode testing. Test Flows can be (a) a subset of actual flows that are stored for active mode testing, (b) a flow that is generated according to a particular VNF's testing purposes, (c) a flow that is generated by Intelligent Flow Selector 1004 meeting a criterion and (d) a flow sent by the controller for testing purposes only.

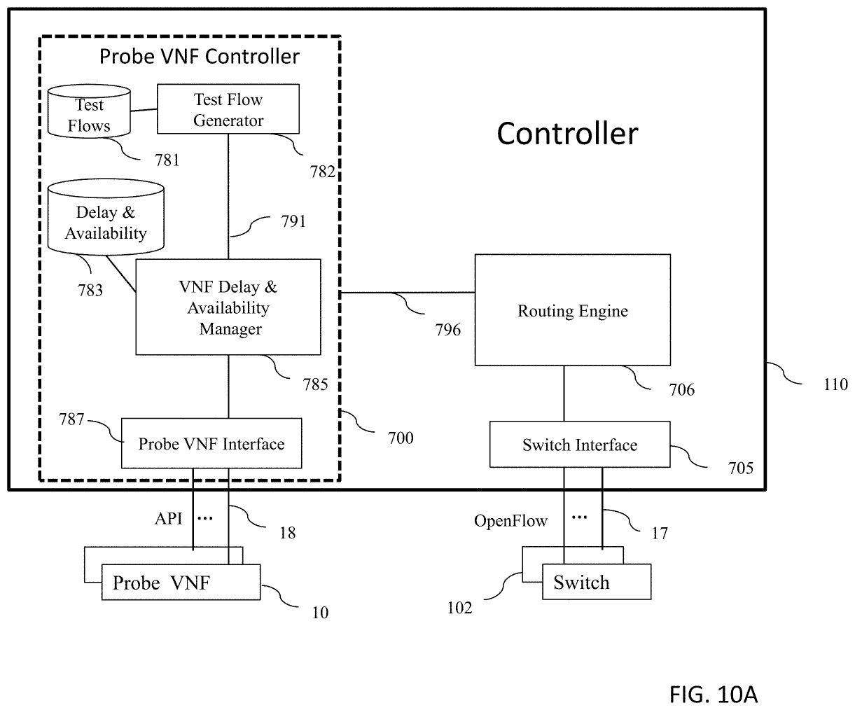

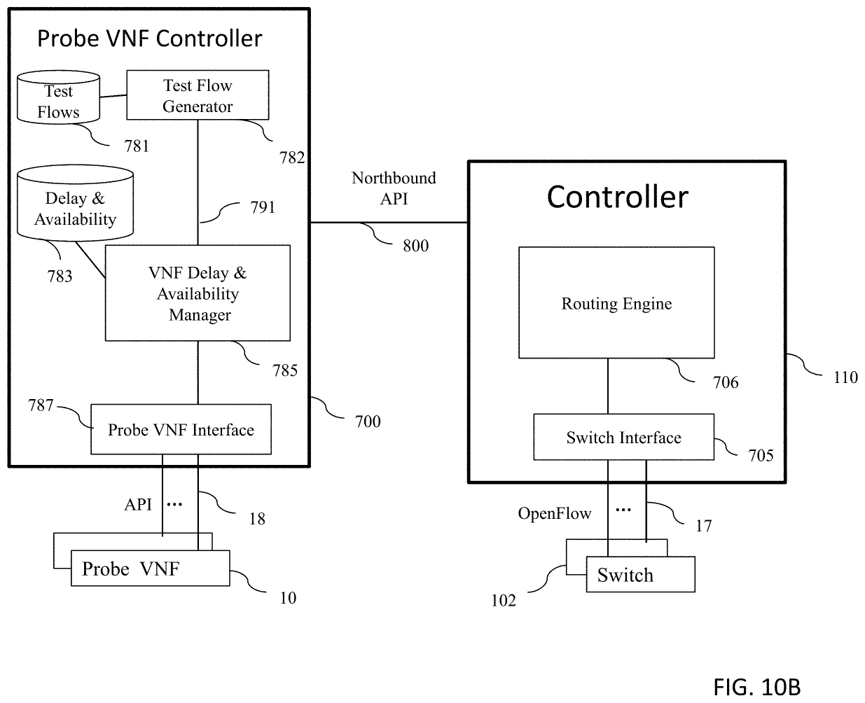

High-level block diagram of two feasible implementations of the control function are illustrated in FIGS. 10A and 10B, wherein Control Function 700 is a sub-function of the Controller, and an external application of the Controller, respectively. Control Function 700 capabilities are identical for both cases. The only difference is that in FIG. 10A, the interface between Control Function 700 and the Controller is an interface that is not exposed, wherein in FIG. 10B, the interface between Control Function 700 and the Controller is an API such as the open Northbound API designed for controller applications. Control Function 700 has interface 18 towards all probe VNFs in the network to initiate a measurement of a specific (or group of) VNF, receive measurement results from the probe VNF, and optionally to send a test flow to be used during measurements. Interface 18 can be an API such as JSON or REST. The control function's heart is VNF Delay and Availability Manager 785 which interfaces with Routing Function 706 with interface 796 to receive a request for a measurement while the routing function is determining which VNF instance to choose, for example, during routing a service function chain that entails at least two VNFs of different types, with each type with many instances distributed throughout the network. The measurement results are stored in DB 783. Control Function 700 optionally has a capability to generate test flows, using function 782, to request probe VNF to perform measurements using a specific test flow. Such test flows are stored in DB 781.

Many of the above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to controllers or processors that may execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

### CONCLUSION

A system and method has been shown in the above embodiments for effectively measuring performance of virtual network functions. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

1. A method implemented in a software defined network (SDN), the SDN comprising: at least one controller, a plurality of switches controlled by the at least one controller, a first virtual network function (VNF₁) providing a telecommunications service to a packet data flow traversing said network, a second virtual network function (VNF₂) providing a service of measuring a delay and an availability of VNF₁, and an interface between VNF₂ and a control function, the method comprising:
a. receiving a request from the control function for measuring a delay of VNF₁ using a specific packet data flow;
b. storing a first arrival time, t₁, and an identifier associated with at least one packet in the specific packet flow, wherein the at least one packet in the specific packet flow arrives for a first time at VNF₂ prior to traversing VNF₁;
c. storing a second arrival time, t₂, of the at least one packet when receiving the specific packet data flow after traversing VNF₁;
d. computing delay of VNF₁ as t₁-t₂;
e. determining an operation status of VNF₁ as ‘available’ when the computed delay of VNF₁ is bounded, and determining the operational status of VNF₁ as ‘unavailable’ when the computed delay is either larger than a predetermined threshold or when the at least one packet fails to arrive after traversing VNF₁; and
f. reporting the computed delay and the determined operation-status of VNF₁ to the control function.

2. The method of claim 1, wherein the identifier is any of, or a combination of, the following: a virtual LAN (VLAN) tag, a Multiprotocol Label Switching (MPLS) tag, a Network Service Header (NSH) tag, and packet sequence number.

3. The method of claim 1, wherein the specific packet data flow originates from a user of the SDN.

4. The method of claim 1, wherein the specific packet data flow is a special test flow originating from VNF₂.

5. The method of claim 4, wherein the special test flow is generated by any of the following: the control function, VNF₂, and an external application.

6. The method of claim 4, wherein the special test flow is generated by VNF₂ through an intelligent processing and filtering of user data flows.

7. The method of claim 1, wherein the step of reporting further comprises reporting any of, or a combination of the following: minimum delay, maximum delay, median delay, availability status, measurement time period, and measurement certainty estimate

8. A method implemented in a software defined network (SDN) comprising: at least one controller, a plurality of switches, each switch in the plurality of switches programmable to use In-Band Telemetry (INT), the plurality of switches controlled by the at least one controller, a first virtual network function (VNF₁) providing a service to a user's packet data flow traversing said network attached to a first switch, a second virtual network function (VNF₂) providing a service of measuring a delay and an availability of VNF₁, and an interface between VNF₂ and a control function, the method comprising:
a. receiving a request from the control function for measuring a delay of VNF₁ using a specific packet data flow;
b. the first switch inserting an In-Band Telemetry (INT) header at a first time of arrival, t₁, of a packet, prior to sending the packet to VNF₁, and recording the first time of arrival, t₁;
c. the first switch updating the INT header at a second time of arrival, t₂, of the packet after receiving packet from VNF₁, and recording the second time of arrival, t₂;
d. the first switch sending the packet to VNF₂;
e. the VNF₂ receiving the packet with the updated INT header and stripping off the INT header;
f. the VNF₂ storing t₁ and t₂ and an identifier associated with the specific packet flow,
g. computing delay of VNF₁ as t₁-t₂;
h. determining an operation status of VNF₁ as ‘available’ when the computed delay of VNF₁ is bounded, and determining the operational status of VNF₁ as ‘unavailable’ when the packet fails to arrive at VNF₂; and
i. reporting the computed delay and the determined operation-status of VNF₁ to the control function.

9. The method of claim 8, wherein the identifier is any of, or a combination of, the following: a virtual LAN (VLAN) tag, a Multiprotocol Label Switching (MPLS) tag, a Network Service Header (NSH) tag, and packet sequence number.

10. The method of claim 8, wherein the specific packet data flow originates from a user of the SDN.

11. The method of claim 8, wherein the specific packet data flow is a special test flow originating from VNF₂.

12. The method of claim 11, wherein the special test flow is generated by any of the following: the control function, VNF₂, and an external application.

13. The method of claim 11, wherein the special test flow is generated by VNF₂ through an intelligent processing and filtering of user data flows.

14. The method of claim 8, wherein the step of reporting further comprises reporting any of, or a combination of the following: minimum delay, maximum delay, median delay, availability status, measurement time period, and measurement certainty estimate

15. A system implemented in a software defined network (SDN) comprising:
a. a database storing information regarding: (1) one or more virtual network functions (VNFs), (2) one or more packet flows, (3) delays associated with VNFs, and (4) availability of VNFs;
b. an interface to a control function to receive requests and to report results;
c. a flow processor receiving at least one packet flow in the one or more packet flows from a switch in a passive mode, the flow processor processes messages from a controller regarding starting a test cycle;
d. a time collector receiving the at least one packet flow processed by the flow processor for extraction and recordation of timing information for delay estimation, the time collector extracting a packet identifier and associated arrival time of the incoming packets and storing extracted information in the database, wherein when a same packet within the at least one packet flow arrives at the time collector after being processed by a VNF within the one or more VNFs, recording the arrival time, estimated delay, and availability information in the database;
e. a reporter reporting the estimated delay and availability information to the controller and a monitoring application; and
f. a test flow generator generating one or more synthetic test packet flows for active mode testing, wherein the one or more synthetic test packet flows are any of the following: (1) first flow that is stored in the database for active mode testing, (2) a second flow that is generated according to a specific VNF's testing purposes, (3) a third flow that is generated by an intelligent flow selector meeting a predefined criterion, and (4) a fourth flow sent by the controller for testing purposes only.

16. The system of claim 15, wherein the database additionally stores any of, or a combination of, the following: one or more rules associated with a specific testing cycle of a specific VNF, one or more flow identifiers, Service Function Chaining (SFC) information, active operation information, passive operation information, INT mode information, and unicast or multicast method and duration.

17. The system of claim 15, wherein the control function triggers measurements of delays and availabilities of co-located VNFs, and the system further comprises: (a) a first interface to a routing function associated with the controller to receive a request for testing of delay of at least one VNF and to report the result back to the routing function, (b) a second interface to send measurement requests and to report results.

18. The system of claim 17, wherein the control function is implemented as a sub-function of the controller.

19. The system of claim 17, wherein the control function is implemented as an application of the controller, the control function interfacing with the controller using an API.
